(19) United States
(12) Patent Application Publication
(10) Pub. No.: US 2026/0169543 A1
(43) Pub. Date: Jun. 18, 2026

(54) DI/DT Management During Clock Gating

(71) Applicant: Google LLC, Mountain View, CA (US)

(72) Inventor: Janardan Prasad, Bangalore (IN)

(73) Assignee: Google LLC, Mountain View, CA (US)

(21) Appl. No.: 19/123,720

(22) PCT Filed: Nov. 11, 2022
(86) PCT No.: PCT/US2022/049702

§ 371 Date: Apr. 23, 2025

(51) Int. Cl. G06F 1/3237

(52) U.S. Cl. CPC G06F 1/3237

(57) ABSTRACT

Methods, systems, and apparatus, for di/dt management during clock gating. One of the apparatus includes a plurality of computing devices, wherein each computing device has respective clock gating logic that is configured to apply clock gating to a portion of the computing device; and a centralized di/dt manager that is configured to perform operations including: receiving, from the plurality of computing devices, respective clock gating requests to perform the clock gating, wherein each clock gating request specifies a respective clock gating value representing how much of the requesting computing device will be clock gated, computing, from the clock gating requests, a total clock gating value of the device, determining, from the total clock gating value, which of the clock gating requests to approve, and providing, the each of the plurality of computing devices, responses to the respective clock gating requests, each response representing whether the clock gating request is approved.

### BACKGROUND

This specification relates to systems having integrated circuit devices.

A system on a chip (SoC) is an integrated circuit that integrates different components of a mobile computing device, including a central processing unit (CPU), memory, input/output ports, cellular radios, and secondary storage, and so on. In contrast to the traditional motherboard-based PC architecture, where a motherboard houses and connects detachable or replaceable components, SoCs integrate all these components into a single integrated circuit. SoCs are commonly used in mobile computing, edge computing, and embedded systems, such as smartphones, tablet computers, WiFi routers, Internet of Things (IoT) devices, and so on.

Clock gating is used in many circuits for reducing dynamic power dissipation, by removing the clock pulse when the circuit is not in use. Clock gating saves power by pruning the clock tree, in some cases, at the cost of adding more logic to a circuit. A SoC can include multiple devices that need clock gating. For example, when a device of the SoC does not need to work for some clock cycles (e.g., 10 clock cycles or 1 clock cycle), the system can determine to perform clock gating for the device, e.g., removing the clock pulse, or switching between “clock on” and “clock off” according to the requirements of that device. When the device needs to come back to work, the system can add back the clock pulse. Clock gating by removing and adding back clock pulses in a device causes changes in the current. Di/dt is the rate-of-change of the current and can be expressed in units of amps per second. A positive di/dt represents an increase in the current and a negative di/dt represents a decrease in the current.

However, when multiple subsystems or multiple components of a device need clock gating, clock gating can result in sudden change in the current requirement of the device. The sudden change in the current is referred to as di/dt noise or the di/dt effect, which is also known as surge current or in-rush current. High performance design of modern devices may require more frequent and higher amount of clock gating, which may result in higher di/dt noise. Thus, di/dt noise is becoming an important source of power supply noise in modern day chips. Di/dt effect increases when clock gating is performed on a significant part of the device.

Some systems can utilize higher noise margins during clock gating to mitigate the di/dt effect. To do so, the system can estimate a di/dt noise percentage and can allocate a sufficient amount of noise margin during which desired work cannot be performed. However, when a large amount of noise margin is allocated in a large size circuit, e.g., a high performance chip, there are fewer opportunities to save the power, e.g., by reducing the voltage or some other techniques. Thus, the system must operate at a lower speed. In addition, the system has to use higher noise margins because of the unpredictability of di/dt noise. The problem becomes more impactful when circuit size goes bigger, such as modern day devices with multiple CPU cores.

Some systems can stagger the clock gating of the multiple components of a device to mitigate the di/dt effect. Staggering is helpful when the clock of an entire component is being gated on or gated off. However, modern day devices may need to perform clock gating for a portion of a component and may need to perform many types of clock gating, e.g., fine grained clock gating, micro textual clock gating, etc. Thus, staggering cannot help when much complex clock gating is happening inside the multiple components of the device.

### SUMMARY

This specification describes technologies for di/dt management during clock gating of multiple computing devices in a system. The techniques use a centralized di/dt manager that can receive clock gating requests from the multiple computing devices and can determine to approve which of the clock gating requests such that the total clock gating value of the system is within a threshold.

The subject matter described in this specification can be implemented in particular embodiments so as to realize one or more of the following advantages. The techniques use a centralized di/dt manager to manage di/dt noise during clock gating of multiple computing devices in a device. The di/dt manager can receive clock gating requests from the multiple computing devices and can determine to approve which of the clock gating requests such that the total clock gating value of the device is within a threshold. Therefore, the techniques can control the di/dt noise to be within a limit and can reduce the noise margin in the device. Therefore, there are more opportunities to save the power, e.g., by lowering the voltage because power is directly proportional to the square of the voltage, or using other techniques, and the system can execute at a higher speed. The techniques can increase the frequency of operation and can finish a task earlier, saving the energy required for a task.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a flowchart of an example for di/dt management during clock gating.

FIG. 3 is a flowchart of an example for di/dt management during clock gating.

Like reference numbers and designations in the various drawings indicate like components.

### DETAILED DESCRIPTION

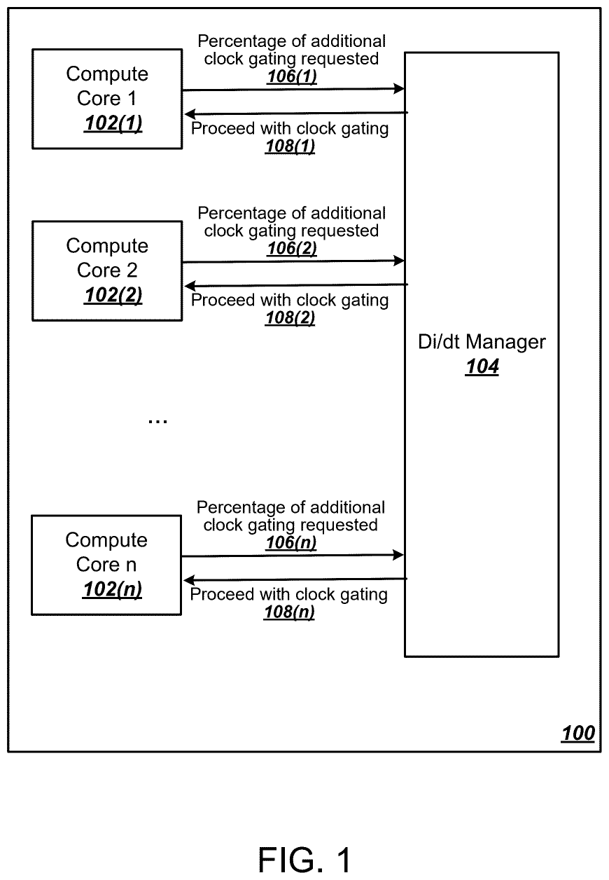

FIG. 1 is a diagram of an example system 100. The system 100 can include a system on a chip (SoC) device installed on a mobile device (e.g., a smart phone or a tablet). A SoC is an integrated circuit system that can include each component of the system on a single silicon substrate or on multiple interconnected dies, e.g., using silicon interposers, stacked dies, or interconnect bridges. Alternatively or in addition, the system 100 can be another type of device that uses centralized clock gating control.

The system 100 includes multiple computing devices, subsystems, or components. For example, the system 100 includes multiple compute cores, e.g., compute core 1 102(1), compute core 2 102(2), . . . , compute core n 102(n), (collectively, “compute cores 102”). For example, the compute cores can be central processing units (CPUs), graphics processing units (GPUs), digital signal processors (DSPs), machine learning tiles, image processors, or any other appropriate types of computing devices. Although the techniques are illustrated for the multiple compute cores 102, similar techniques are applicable to any kind of device which have multiple computing devices, subsystems, or components.

Each computing device, e.g., each compute core, has respective clock gating logic that is configured to apply clock gating to a portion of the computing device. Clock gating is a technique used in many circuits for reducing dynamic power dissipation, by removing, or holding steady, a clock pulse when the circuit is not in use. Clock gating saves power by pruning the clock tree, at the cost of adding more logic to a circuit. Some devices may need to perform clock gating for a portion of a component and may need to perform many types of clock gating, e.g., fine grained clock gating, micro textual clock gating, etc.

For example, a CPU core may not need to work for some clock cycles (e.g., 10 clock cycles, 5 clock cycles, or 1 clock cycle), the CPU core may desire to perform clock gating, e.g., removing the clock pulse according to the requirements of the CPU core. After a period of time, the CPU core may need to come back to work, and the CPU core may desire to end the clock gating, e.g., adding back the clock pulse according to the requirements of the CPU core. In some examples, a portion of the CPU core may not be required to work for some clock cycles.

Clock gating by removing and adding back clock pulses in a device causes changes in the current. Di/dt is the rate-of-change of the current and can be expressed in units of amps per second. A positive di/dt represents an increase in the current and a negative di/dt represents a decrease in the current. When multiple subsystems or multiple components of a device need clock gating, clock gating can result in sudden change in the current of the device. The sudden change in the current is referred to as di/dt noise or the di/dt effect, which is also known as surge current or in-rush current. High performance design of modern devices may require more frequent and higher amount of clock gating, which may result in higher di/dt noise. Thus, di/dt noise is becoming an important source of power supply noise in modern day chips. Di/dt effect increases when clock gating is performed on a significant part of the device.

The system 100 includes a centralized di/dt manager 104. The di/dt manager 104 can control the di/dt noise by managing clock gating requests from the multiple computing devices in the system 100. The di/dt manager 104 can control the di/dt noise to be within a limit and can reduce the noise margin in the system 100. Therefore, there are more opportunities to save the power, e.g., by reducing the voltage or some other techniques, and the system 100 can perform at a higher speed.

The di/dt manager 104 can receive, from the compute cores 102, respective clock gating requests 106(1), 106(2), . . . , 106(n) (collectively, 106), to perform the clock gating. Each clock gating request 106 specifies a respective clock gating value representing how much of the requesting compute core will be clock gated. In some implementations, the clock gating value can represent a percentage of clock gating that a compute core desires to perform in a particular clock cycle.

For example, the CPU core 1 102(1) can be in an operating state at a first time point. At a second time point after the first time point, the CPU core 1 102(1) may determine that the number of instructions being processed by the core has reduced. The CPU core may determine to perform clock gating for a portion of the CPU core. The di/dt manager 104 can receive, from the CPU core 1 102(1), a clock gating request 106(1), to perform the clock gating. The clock gating request 106(1) can include a percentage, e.g., 50%, of clock gating that the CPU core 1 102(1) desires to perform in a particular clock cycle. In some implementations, the CPU core may be already under clock gating, and the clock gating request 106(1) can include a percentage, e.g., 25%, of additional clock gating that the CPU core 1 102(1) desires to perform in a particular clock cycle.

The di/dt manager 104 can compute, from the clock gating requests 106, a total clock gating value of the system 100. For example, the di/dt manager 104 can compute the total clock gating value of the system 100 by calculating a sum of the respective percentage of additional clock gating requested. In some implementations, the di/dt manager 104 can calculate a weighted sum of the respective percentage of additional clock gating requested, and the weight can be proportional to a size of the computing device or a frequency of the computing device, or a combination of both.

The di/dt manager 104 can determine, from the total clock gating value, which of the clock gating requests from the plurality of compute cores 102 to approve. The di/dt manager 104 can compare the total clock gating value to a clock gating threshold of the system 100. The total clock gating value is the maximum amount of clock gating that can be allowed without severely impacting the performance of the system 100, e.g., without requiring high noise margins. The di/dt manager 104 can obtain the total clock gating value after post silicon measurement and/or characterization, and can store the total clock gating value in a register, e.g., a control and status registers (CSR) or any programmable register, included in the di/dt manager 104. In some implementations, the di/dt manager 104 can burn the total clock gating value in fuses for production parts.

In some implementations, if the total clock gating value is less than the clock gating threshold, the di/dt manager 104 can approve the clock gating requests from all of the compute cores 102. In some implementations, if the total clock gating value is greater than the clock gating threshold, the di/dt manager 104 can approve the clock gating requests from fewer than all of the compute cores 102. In some implementations, the di/dt manager 104 can select a combination of the compute cores 102 whose clock gating values are less than the clock gating threshold, and can approve the clock gating requests from the selected combination of compute cores. Thus, the di/dt manager 104 can make sure that the total allowed clock gating is within a limit and can reduce the noise margin in the device.

The di/dt manager 104 can provide the compute cores 102, responses 108(1), 108(2), . . . , 108(n) (collectively, 108) to the respective clock gating requests 106. Each response 108 can represent whether the clock gating request 106 is approved. For example, the di/dt manager 104 can provide the compute core 102(1) a response 108(1), and the response 108(1) can be “proceed with clock gating”, representing that the clock gating request 106(1) is approved.

The communication between the di/dt manager 104 and the compute cores 102 can be implemented in various ways. In some implementations, the system 100 can include a physical interface for the communication. For example, the physical interface for the communication can include a set of signals between the compute cores 102 and the di/dt manager 104. The set of signals can inform the di/dt manager 104 the amount of clock gating a compute core is planning to do, and the set of signals can include approvals or rejections from the di/dt managers. In some implementations, the system 100 can include a virtual interface for the communication. For example, the system 100 can implement the communication between the compute cores 102 and the di/dt manager 104 via reading a status of one or more sensors, or via reading a status of one or more registers, without using a set of physical signals. In some implementations, the system 100, e.g., the di/dt manager 104, can include a plurality of status registers, e.g., control and status registers (CSR), and the status registers can store the request 106, the responses 108, or a combination of both. In some implementations, the system 100 can include a plurality of sensors, e.g., current sensors, for the communication between the di/dt manager 104 and the compute cores 102. Other implementations are also possible.

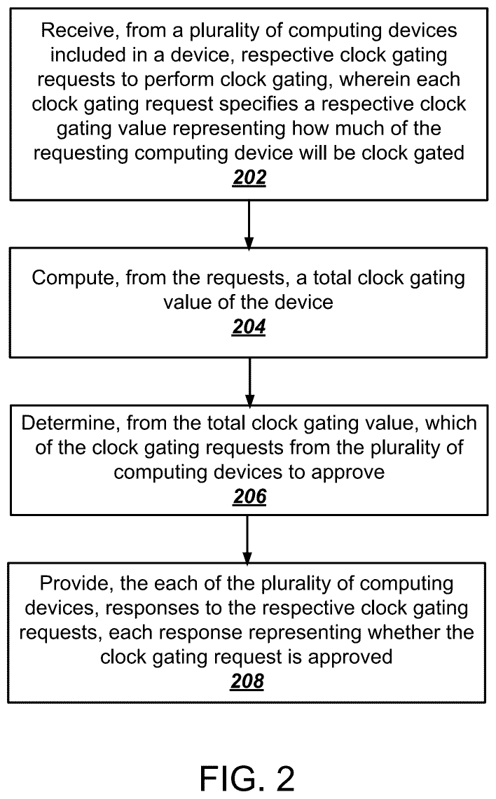

FIG. 2 is a flowchart of an example for di/dt management during clock gating. For convenience, the process will be described as being performed by the system 100 that includes a di/dt manager 104. The system can include the components described in reference to FIG. 1, including one or more computing devices, subsystems, components, or some combination of these.

The system receives, from a plurality of computing devices, respective clock gating requests to perform the clock gating (202). Each clock gating request can specify a respective clock gating value representing how much of the requesting computing device will be clock gated. In some implementations, each clock gating value can represent a percentage of a computing device that is to be clock gated. For example, each clock gating value can represent a percentage of clock gating each core 102 desires to perform during a clock cycle.

The system 100 can include the plurality of computing devices and a centralized di/dt manager. In some implementations, the centralized di/dt manager and the plurality of computing devices can be integrated on a single system on a chip. For example, the system 100 can be a system on a chip (SoC), and the SoC can include a di/dt manager and a plurality of computing devices, such as subsystems, components, computing devices, or a combination of these.

Each computing device can have respective clock gating logic that can be configured to apply clock gating to a portion of the computing device. In some implementations, each computing device can apply or perform the requested clock gating if and only if the centralized di/dt manager 104 has provided a response approving the clock gating request.

The system computes, from the clock gating requests, a total clock gating value of the device (204). In some implementations, each of the plurality of computing devices can be associated with a weight, and the system can compute the total clock gating value of the device by multiplying the clock gating value of each request by a respective weight from the requesting computing device. The weight from the requesting computing device can be stored in the di/dt manager, e.g., in a CSR register or any programmable register, of the di/dt manager. In some implementations, the weights can be burned in fuses for production parts.

In some implementations, the weight can be determined based on a size of the computing device, a frequency of the computing device, the voltage of operation and technology cells, or a combination of these. For example, the sizes of the cores 102 can be different. One core can be 1 square nanometer, and another core can be 0.1 square millimeter or 0.1 square micrometer. When the cores 102 are communicating the clock gating requests, the overall effect from the cores can be different. As another example, the frequencies of the cores 102 can be different. One core can be 1.5 GHz, and another core can be 5 GHz. When the cores 102 are communicating the clock gating requests, the overall effect from the cores can be different. In some implementations, the weights for each computing device can be determined after post silicon measurement and/or characterization.

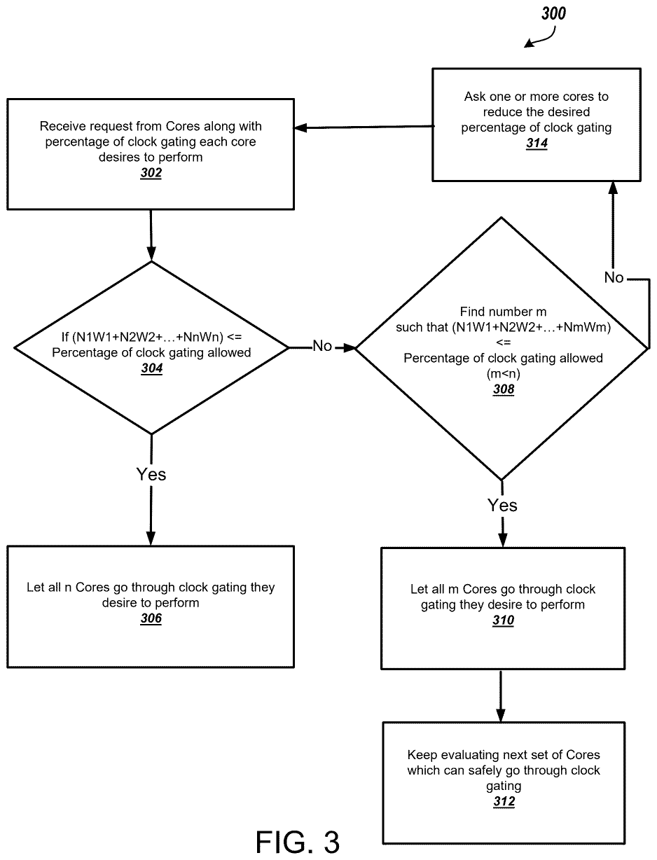

FIG. 3 is a flowchart of an example 300 for di/dt management during clock gating. A di/dt manager can receive requests from a plurality of computing devices, e.g., cores, along with percentage of clock gating each core desires to perform (302). The percentage of clock gating each core desires to perform can be N1, N2, . . . , Nn, for a total of n cores indexed from 1 to n. The di/dt manager can compute a total clock gating value of the cores (304). Each core can have a respective weight W1, W2, . . . , Wn. The total clock gating value of the device can be a weighted sum of the percentage of clock gating each core desires to perform, e.g., N1W1+N2W2+. . . +NnWn.

Referring back to FIG. 2, the system determines, from the total clock gating value, which of the clock gating requests from the plurality of computing devices to approve (206). In some implementations, the system can compare the total clock gating value to a clock gating threshold of the device. The system can determine that the total clock gating value is less than the clock gating threshold, and in response, the system can approve the clock gating requests from all of the computing devices.

In some implementations, the system can compare the total clock gating value to a clock gating threshold of the device. The system can determine that the total clock gating value is greater than the clock gating threshold, and in response, the system can provide approvals to fewer than all of the plurality of computing devices. In some implementations, the system can select a combination of the plurality of computing devices whose clock gating values are less than the clock gating threshold, and can provide approvals to the selected combination of the plurality of computing devices.

The system provides, each of the plurality of computing devices, responses to the respective clock gating requests, each response representing whether the clock gating request is approved (208).

Referring to FIG. 3, the di/dt manager can compare the total clock gating value to a clock gating threshold of the device (304). For example, the di/dt manager can determine whether the total clock gating value, e.g., N1W1+N2W2+. . . +NnWn, satisfies a criterion, e.g., not larger than the percentage of clock gating allowed for the device.

The di/dt manager can include a CSR that stores the clock gating threshold of the device. In some implementations, the limit of allowed percentage of clock gating may change over time, and the di/dt manager can include a CSR that stores the clock gating threshold of the device at any given time point.

If N1W1+N2W2+. . . +NnWn is not larger than the percentage of clock gating allowed, the di/dt manager can let all n cores go through clock gating that they desire to perform (306). For example, the di/dt manager 104 can determine that the total clock gating value from all compute cores 102 is less than the clock gating threshold. In response, the di/dt manager 104 can approve the clock gating requests 106 from all the compute cores 102. The di/dt manager 104 can provide response 108 to all the cores 102, and each response can represent that the clock gating request is approved.

If N1W1+N2W2+... +NnWn is larger than the percentage of clock gating allowed, the di/dt manager can find a number m such that N1W1+N2W2+. . . +NmWm is not larger than the percentage of clock gating allowed for the device (308). Here, m is a positive integer that is smaller than the total number of cores n.

If the di/dt manager can find a number m such that N1W1+N2W2+. . . +NmWm is not larger than the percentage of clock gating allowed for the device, the di/dt manager can let all m cores go through clock gating that they desire to perform (310). In some cases, the di/dt manager can find only one core that can go through clock gating.

For example, the di/dt manager 104 can determine that the total clock gating value from all CPU cores 102 is larger than the clock gating threshold, and the total clock gating value from the CPU cores 102(1), 102(2), and 102(3) is not larger than the clock gating threshold. In response, the di/dt manager 104 can approve the clock gating requests 106 from the CPU cores 102(1), 102(2), and 102(3). The di/dt manager 104 can provide responses 108 to the CPU cores 102(1), 102(2), and 102(3), indicating that the respective clock gating request is approved. The di/dt manager 104 can provide responses 108 to the rest of the CPU cores, indicating that the respective clock gating request is not approved.

If the di/dt manager cannot find a number m (m is a positive integer smaller than n) such that N1W1+N2W2+. . . +NmWm is not larger than the percentage of clock gating allowed for the device, the di/dt manager can determine that none of the cores can go through clock gating. In some implementations, the di/dt manager can ask one or more cores to reduce the desired percentage of clock gating (314).

The di/dt manager can keep evaluating the next set of cores which can safely go through clock gating (312). For example, during the next clock cycle, the di/dt manager can reevaluate the compute cores 102(4), . . . , 102(n) that were not approved for clock gating in the previous clock cycle. The di/dt manager can determine that the total clock gating value from the compute cores 102(4), . . . , 102(n) is not larger than the clock gating threshold. In response, the di/dt manager 104 can approve the clock gating requests from the compute cores 102(4), . . . , 102(n). The di/dt manager 104 can provide responses to the compute cores 102(4), . . . , 102(n), indicating that the respective clock gating request is approved.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client device having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a device comprising:
a plurality of computing devices, wherein each computing device has respective clock gating logic that is configured to apply clock gating to a portion of the computing device; and
a centralized di/dt manager that is configured to perform operations comprising:
   receiving, from the plurality of computing devices, respective clock gating requests to perform the clock gating, wherein each clock gating request specifies a respective clock gating value representing how much of the requesting computing device will be clock gated,
   computing, from the clock gating requests, a total clock gating value of the device,
   determining, from the total clock gating value, which of the clock gating requests from the plurality of computing devices to approve, and
   providing, the each of the plurality of computing devices, responses to the respective clock gating requests, each response representing whether the clock gating request is approved.

Embodiment 2 is the device of embodiment 1, wherein each computing device applies the requested clock gating if and only if the centralized di/dt manager has provided a response approving the clock gating request.

Embodiment 3 is the device of embodiment 1, wherein determining which of the clock gating requests to approve comprises:
comparing the total clock gating value to a clock gating threshold of the device;
determining that the total clock gating value is less than the clock gating threshold; and
in response, approving the clock gating requests from all of the computing devices.

Embodiment 4 is the device of embodiment 1, wherein determining which of the clock gating requests to approve comprises:
comparing the total clock gating value to a clock gating threshold of the device;
determining that the total clock gating value is greater than the clock gating threshold; and
in response, providing approvals to fewer than all of the plurality of computing devices.

Embodiment 5 is the device of embodiment 4, wherein providing the approvals to fewer than all of the plurality of computing devices comprises selecting a combination of the plurality of computing devices whose clock gating values are less than the clock gating threshold.

Embodiment 5 is the device of embodiment 1, wherein each of the plurality of computing devices is associated with a weight, and wherein computing the total clock gating value of the device comprises multiplying the clock gating value of each request by a respective weight from the requesting computing device.

Embodiment 7 is the device of embodiment 6, wherein the weight is proportional to a size of the computing device or a frequency of the computing device.

Embodiment 8 is the device of embodiment 1, wherein each clock gating value represents a percentage of a computing device that is to be clock gated.

Embodiment 9 is the device of embodiment 1, wherein the centralized di/dt manager and the plurality of computing devices are integrated on a single system on a chip.

Embodiment 10 is a method, comprising:
receiving, by a centralized di/dt manager included in a device and from a plurality of computing devices, respective clock gating requests to perform clock gating, wherein each computing device has respective clock gating logic that is configured to apply the clock gating to a portion of the computing device, wherein each clock gating request specifies a respective clock gating value representing how much of the requesting computing device will be clock gated;
computing, by the centralized di/dt manager and from the clock gating requests, a total clock gating value of the device;
determining, by the centralized di/dt manager and from the total clock gating value, which of the clock gating requests from the plurality of computing devices to approve; and
providing, the each of the plurality of computing devices by the centralized di/dt manager, responses to the respective clock gating requests, each response representing whether the clock gating request is approved.

Embodiment 11 is one or more non-transitory storage media encoded with instructions that when executed by a centralized di/dt manager included in a device cause the di/dt manager to perform operations comprising:
receiving, from a plurality of computing devices, respective clock gating requests to perform clock gating, wherein each computing device has respective clock gating logic that is configured to apply the clock gating to a portion of the computing device, wherein each clock gating request specifies a respective clock gating value representing how much of the requesting computing device will be clock gated;
computing, from the clock gating requests, a total clock gating value of the device;
determining, from the total clock gating value, which of the clock gating requests from the plurality of computing devices to approve; and
providing, the each of the plurality of computing devices, responses to the respective clock gating requests, each response representing whether the clock gating request is approved.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A device comprising:
a plurality of computing devices, wherein each computing device has respective clock gating logic that is configured to apply clock gating to a portion of the computing device; and
a centralized di/dt manager that is configured to perform operations comprising:
receiving, from the plurality of computing devices, respective clock gating requests to perform the clock gating, wherein each clock gating request specifies a respective clock gating value representing how much of the requesting computing device will be clock gated;
computing, from the clock gating requests, a total clock gating value of the device;
determining, from the total clock gating value, which of the clock gating requests from the plurality of computing devices to approve, such that a total approved clock gating is less than a clock gating threshold of the device; and
providing, the each of the plurality of computing devices, responses to the respective clock gating requests, each response representing whether the clock gating request is approved.

2. The device of claim 1, wherein each computing device applies the requested clock gating if and only if the centralized di/dt manager has provided a response approving the clock gating request.

3. The device of claim 1, wherein determining which of the clock gating requests to approve comprises:
comparing the total clock gating value to the clock gating threshold of the device;
determining that the total clock gating value is less than the clock gating threshold; and
in response, approving the clock gating requests from all of the computing devices.

4. The device of claim 1, wherein determining which of the clock gating requests to approve comprises:
comparing the total clock gating value to the clock gating threshold of the device;
determining that the total clock gating value is greater than the clock gating threshold; and
in response, providing approvals to fewer than all of the plurality of computing devices.

5. The device of claim 4, wherein providing the approvals to fewer than all of the plurality of computing devices comprises selecting a combination of the plurality of computing devices whose clock gating values are less than the clock gating threshold.

6. The device of claim 1, wherein each of the plurality of computing devices is associated with a weight, and wherein computing the total clock gating value of the device comprises multiplying the clock gating value of each request by a respective weight from the requesting computing device.

7. The device of claim 6, wherein the weight is proportional to a size of the computing device or a frequency of the computing device.

8. The device of claim 1, wherein each clock gating value represents a percentage of a computing device that is to be clock gated.

9. The device of claim 1, wherein the centralized di/dt manager and the plurality of computing devices are integrated on a single system on a chip.

10. A method, comprising:
receiving, by a centralized di/dt manager included in a device and from a plurality of computing devices, respective clock gating requests to perform clock gating, wherein each computing device has respective clock gating logic that is configured to apply the clock gating to a portion of the computing device, wherein each clock gating request specifies a respective clock gating value representing how much of the requesting computing device will be clock gated;
computing, by the centralized di/dt manager and from the clock gating requests, a total clock gating value of the device;
determining, by the centralized di/dt manager and from the total clock gating value, which of the clock gating requests from the plurality of computing devices to approve, such that a total approved clock gating is less than a clock gating threshold of the device; and
providing, the each of the plurality of computing devices by the centralized di/dt manager, responses to the respective clock gating requests, each response representing whether the clock gating request is approved.

11. The method of claim 10, wherein each computing device applies the requested clock gating if and only if the centralized di/dt manager has provided a response approving the clock gating request.

12. The method of claim 10, wherein determining which of the clock gating requests to approve comprises:
comparing the total clock gating value to the clock gating threshold of the device;
determining that the total clock gating value is less than the clock gating threshold; and
in response, approving the clock gating requests from all of the computing devices.

13. The method of claim 10, wherein determining which of the clock gating requests to approve comprises:
comparing the total clock gating value to the clock gating threshold of the device;
determining that the total clock gating value is greater than the clock gating threshold; and
in response, providing approvals to fewer than all of the plurality of computing devices.

14. The method of claim 13, wherein providing the approvals to fewer than all of the plurality of computing devices comprises selecting a combination of the plurality of computing devices whose clock gating values are less than the clock gating threshold.

15. The method of claim 10, wherein each of the plurality of computing devices is associated with a weight, and wherein computing the total clock gating value of the device comprises multiplying the clock gating value of each request by a respective weight from the requesting computing device.

16. The method of claim 15, wherein the weight is proportional to a size of the computing device or a frequency of the computing device.

17. The method of claim 10, wherein each clock gating value represents a percentage of a computing device that is to be clock gated.

18. The method of claim 10, wherein the centralized di/dt manager and the plurality of computing devices are integrated on a single system on a chip.

19. One or more non-transitory storage media encoded with instructions that when executed by a centralized di/dt manager included in a device cause the di/dt manager to perform operations comprising:
receiving, from a plurality of computing devices, respective clock gating requests to perform clock gating, wherein each computing device has respective clock gating logic that is configured to apply the clock gating to a portion of the computing device, wherein each clock gating request specifies a respective clock gating value representing how much of the requesting computing device will be clock gated;
computing, from the clock gating requests, a total clock gating value of the device;
determining, from the total clock gating value, which of the clock gating requests from the plurality of computing devices to approve, such that a total approved clock gating is less than a clock gating threshold of the device; and
providing, the each of the plurality of computing devices, responses to the respective clock gating requests, each response representing whether the clock gating request is approved.

20. The non-transitory storage media of claim 19, wherein each computing device applies the requested clock gating if and only if the centralized di/dt manager has provided a response approving the clock gating request.
